(19) United States
(12) Patent Application Publication
(10) Pub. No.: US 2012/0110072 A1
(43) Pub. Date: May 3, 2012

(54) Method and System for Assessing Social Media Skills of User

(76) Inventor: William Johannes de Villiers, (US)

(21) Appl. No.: 12/916,787

(22) Filed: Nov. 1, 2010

(51) Int. Cl. G06F 15/16

(52) U.S. Cl. 709/204

(57) ABSTRACT

The present disclosure provides a method for assessing social media skills of a user registered on multiple networks. The method includes providing a questionnaire having questions related to one or more networks to the user, and evaluating social media knowledge of the user based on answers provided by the user in the questionnaire. Further, the method includes receiving login details of an account for at least one network of the networks of the user, logging into the at least one network of with the received login details, and evaluating social media presence of the user for the at least one network based on a pre-defined criteria. Moreover, the method includes assessing the social media skills of user for the network based on result of evaluation of the social media knowledge and the social media presence. Further, disclosed is a system for assessing social media skills of a user.

### FIELD OF THE DISCLOSURE

The present disclosure generally relates to a method and a system for assessing social media skills of a user, and more particularly, to a method and a system for assessing social media skills of a user based on social media knowledge and social media presence of the user.

### BACKGROUND OF THE DISCLOSURE

Social media has evolved considerably in recent years. The term ‘social media’ as mentioned herein refers to websites and networks that allow users to share content including photos and videos. Common examples of such websites and networks include popular social networking sites, such as Friendster, Facebook and MySpace, image and video sharing sites, such as. YouTube, Photobucket and Flickr, and content sharing weblogs, blogs and the like.

With the evolution of concept of social media, concept of ‘social media experts’ has also evolved simultaneously. These so called social media experts manage communities, tweet, blog, and engage on sites like Facebook on behalf of a brand. Usually, a true social media expert has a strong online presence, impeccable online communication skills, and has an engaging personality.

With the exponential growth in the field of social media, the number of people proclaiming themselves as social media experts has also increased considerably. However, it has been found that claims of most of these social media experts are incorrect. Many such experts claiming to be qualified or accredited experts are actually without basic skills. This has made the consumers wary of anyone calling himself or herself as a social media expert. Accordingly, there is a strict need of a standard of accreditation in the social media industry. More specifically, there is a strict need to have a tool that evaluates social media skills of a user and provides an indisputable standard for the minimum requirement to be seen as an expert on a specific or multiple social media platforms.

There are many courses and few certificate programs that accredit individuals as social media experts; however, none of these courses and certificate programs provide an indisputable and comprehensive assessment of social media skills of the individual partaking in the accreditation. Therefore, there is a strict need of developing a tool for comprehensive assessment and accreditation of social media skills of individuals by setting a standard in an industry without standards.

### SUMMARY OF THE INVENTION

In view of the foregoing disadvantages inherent in the prior-art, the general purpose of the present disclosure is to provide a method, a system and computer program product for assessing social media skills of a user. The method, system and computer program product is configured to include all advantages of the prior art and to overcome the drawbacks inherent in the prior art offering some added advantages.

In one aspect, the present disclosure provides a method for assessing social media skills of a user registered on a plurality of networks. The method includes providing a questionnaire to the user. The questionnaire includes one or more questions related to one or more networks of the plurality of networks. Further, the method includes evaluating social media knowledge of the user based on answers provided by the user in the questionnaire. Furthermore, the method includes receiving login details of an account for at least one network of the plurality of networks of the user, and logging into the at least one network of the plurality of networks with the received login details. Moreover, the method includes evaluating social media presence of the user for the at least one network of the plurality of networks based on a pre-defined criteria. In addition, the method includes assessing the social media skills of user for the at least one network of the plurality of networks based on result of evaluation of the social media knowledge and the social media presence.

In another aspect, the method includes a system for assessing social media skills of a user registered on a plurality of networks. The system includes a questionnaire module for providing a questionnaire to the user. The questionnaire includes one or more questions related to one or more networks. Further, the system includes a first evaluation module for evaluating social media knowledge of the user based on answers provided by the user to the questionnaire. Furthermore, the system includes a reception module for receiving login details of an account from the user. The login details provided by the user for at least one network of the plurality of networks of the user. Moreover, the system includes a login module for logging into the at least one network of the plurality of networks with the received login details and a second evaluation module for evaluating social media presence of the user for the at least one network of the plurality of networks based on a pre-defined criteria. In addition, the system includes an assessment module for assessing the social media skills of user for the at least one network of the plurality of networks. The assessment is based on result of evaluation of the social media knowledge and the social media presence.

In another aspect, the present disclosure provides a computer program product including a computer usable medium having a computer readable program code stored thereon for assessing social media skills of a user registered on a plurality of networks. The computer program product performing the step of providing a questionnaire, having one or more questions related to one or more networks, to the user. The computer program product further performing the step of evaluating social media knowledge of the user based on answers provided by the user to the questionnaire. Furthermore, the computer program product performs the step of receiving login details of an account from a user for at least one network of the plurality of networks of the user, and logging into the at least one network of the plurality of networks with the received login details. Moreover, the computer program product performs the step of evaluating social media presence of the user for the at least one network of the plurality of networks based on a pre-defined criteria, and assessing the social media skills of user for the at least one network of the plurality of networks based on result of evaluation of the social media knowledge and the social media presence.

### BRIEF DESCRIPTION OF THE DRAWINGS

The advantages and features of the present disclosure will become better understood with reference to the following detailed description and claims taken in conjunction with the accompanying drawing, in which:

FIG. 1 is a block diagram of a method for assessing social media skills of a user registered on multiple networks; and

FIG. 2 is a block diagram of a system for assessing social media skills of a user registered on multiple networks.

### DETAILED DESCRIPTION OF THE DISCLOSURE

The exemplary embodiments described herein detail for illustrative purposes are subject to many variations in structure and design. It should be emphasized, however, that the present disclosure is not limited to a particular method and system for assessing social media skills of a user registered on a plurality of networks as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The use of terms “including,” “comprising,” or “having” and variations thereof herein is meant to encompass the items listed thereafter and equivalents thereof as well as additional items. Further, the terms, “a” and “an” herein do not denote a limitation of quantity, but rather denote the presence of at least one of the referenced item.

The present disclosure provides a method and a system for assessing social media skills of a user registered on a plurality of networks. The term ‘user’ as mentioned herein refers to an individual, who wants his or her social media expertise assessed. The term ‘networks’ as mentioned herein refers to social media networks, such as social networking sites, blogs, weblogs, professional networking sites, general websites, wikis, video-sharing sites, and the like. However, it should be clearly understood that the examples of social media networks as mentioned herein should not be construed as a limitation to the present disclosure.

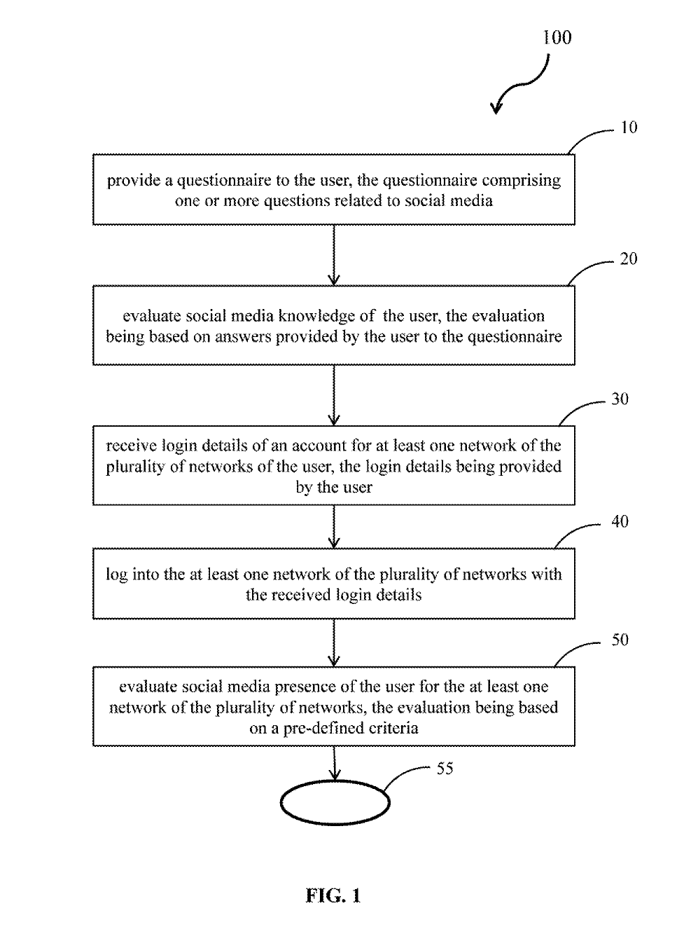

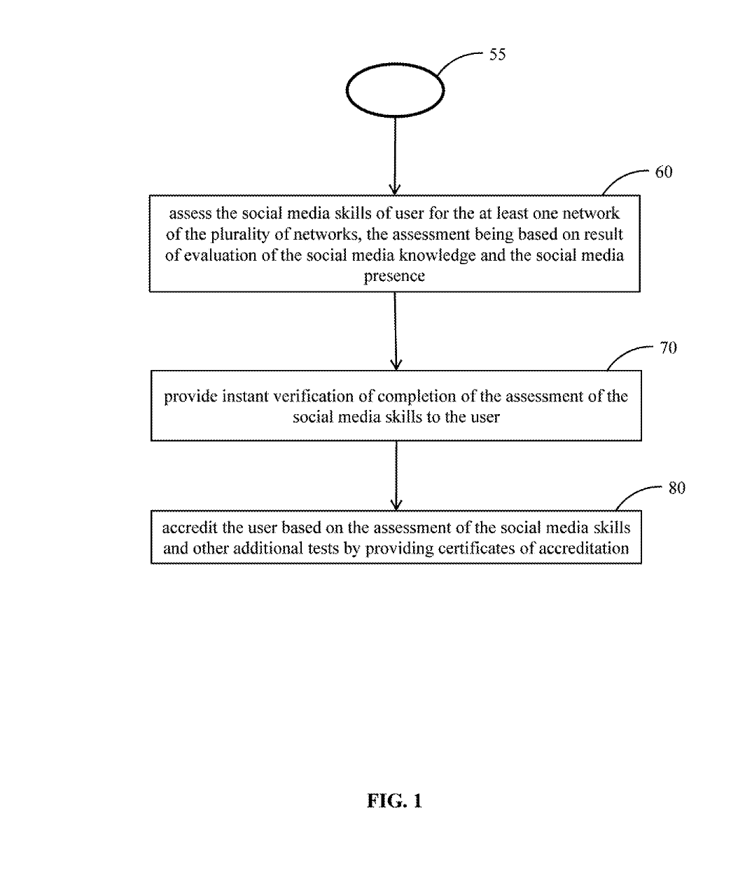

The method for assessing social media skills of a user registered on a plurality of networks will now be described in conjunction to FIG. 1. As shown in FIG. 1, the method 100 includes providing a questionnaire to the user, at block 10. The questionnaire includes one or more questions related to social media, and, more specifically to one or more networks of the plurality of networks. More specifically, the questionnaire may be devised to determine whether the claims of expertise of the user are legitimate. The questionnaire may include objective type questions or subjective type questions. The objective type questions may be responded by the user by selecting at least one choice of multiple choices provided to the user. The subjective type questions may be responded by the user by writing brief answers to the questions. Alternatively, the questionnaire may include both objective type and subjective type questions. Few exemplary questions included in the questionnaire may be:

Q 1: What is social media?

Q 2: What is a social media campaign?

Q 3: How do you monitor social media for a client?

Q 4: How do you build an audience?

The method 100 may further include evaluating social media knowledge of the user, at block 20. The evaluation is based on answers provided by the user to the questionnaire. More specifically, the answers provided by the user are parsed to determine an evaluated score of the user. Alternatively, the answers provided by the user may be parsed to determine whether the user has a minimum level of social media knowledge required or not. It will be apparent to a person skilled in the art that the result of evaluation in this case may be a ‘Pass’ or a ‘Fail’. Further, the evaluation of the answers may be performed using standard evaluation software modified to conform to the requirements of the method 100. Alternatively, the evaluation may be performed by human intervention.

After the evaluation of the social media knowledge, the method 100 may include receiving login details of an account for at least one network of the plurality of networks of the user, at block 30. More specifically, the method 100 may include receiving the login details from the user of at least one network on which he is registered. For example, the user may provide login details about the social networking website on which he or she may be registered. The term ‘login details’ as mentioned herein refers to personal details, such as a username and password, that the user may utilize for accessing the at least one network. This information may be used by method 100 to corroborate the presence of the user for the networks the user claims he or she is present on.

After receiving the logging details, the method 100 may include logging into the at least one network, say the social networking website, with the received login details. A successful login may corroborate the presence of the user on the network, whereas, an unsuccessful login may question the veracity of the claims of the user. It should be understood that an unsuccessful login into the network, may allow method 100 to prompt the user about the failure of the login attempt, and may thereafter allow the user to enter correct login details for a predetermined number of times.

After logging into the at least one network, the method 100 may evaluate social media presence of the user for the at least one network, at block 50. The evaluation may be based on a pre-defined criterion. In one embodiment of the present disclosure, the evaluation may be based on one or more of whether the account of the user is active, whether profile of the user exists, whether there is a profile image uploaded, whether the account contains posts, whether the account has content both video and audio, whether the account has multiple posts, whether the account is linked to other websites, and whether the posts contains tags. However, it should be clearly understood that the evaluation of the social media presence based on the pre-defined criterion as mentioned herein should not be construed as a limitation to the present disclosure. Therefore, the evaluation of the social media presence may be based on any other pre-defined criteria.

The evaluation may be performed by a standard evaluation tool, which may be adapted to suit the requirements of the method 100. The standard evaluation tool may be configured to parse content and check the integrity of the content. More specifically, the standard evaluation tool may be configured to communicate with Application Programming Interface (API) of the at least one network to retrieve the required information for validation. Additionally, the evaluation tool may use Open Authentication Method (OAM) to communicate with social media sites. Alternatively, the evaluation may be performed by human intervention. Again, the standard evaluation tool may either provide an evaluation score based on the parsing. Alternatively, the standard evaluation tool may determine whether the user has a minimum level of social media knowledge required or not. It will be apparent to a person skilled in the art that the result of evaluation in this case may be a ‘Pass’ or a ‘Fail’.

The method 100 further includes assessing the social media skills of user for the at least one network, at block 60. The assessment may be based on result of evaluation of the social media knowledge obtained at block 20 and the evaluation of social media presence obtained at block 50. More specifically, the assessment may be done by taking into account the combined evaluation scores obtained by the user with respect to the social media knowledge and the social media presence. If the combined score is above a minimum combined score than the assessment of the user may be successful. Alternatively, the assessment may be done based on whether the user has the minimum level of the social media knowledge and the social media presence. For example, if the user has been assessed successfully in both the social media knowledge and the social media presence, the assessment may be successful.

After the assessment of the social media skills, the method 100 may include providing instant verification of completion of the assessment of the social media skills to the user, at block 70. Thereafter, the method 100 may accredit the user, at block 80, based on the assessment of the social media skills. However, it should be clearly understood that such accreditation based on the social media skills should not be construed as a limitation to the present disclosure. Accordingly, other accreditation may be provided from time and again to certify the user. In one embodiment of the present disclosure, in some cases, the accreditation may be based on evaluation of social media presence of the user.

The accreditation of the user may signify that the user has been successfully assessed by the method 100. More specifically, the accreditation confirms indisputably that the test taker adheres to a minimum requirement to be considered an expert in that specific social media platform. Further, the accreditation may include one or more levels of accreditation, wherein the one or more levels correspond to the result of the social media skills assessment. Accordingly, the user has to have successful assessment in a minimum number of networks to obtain the accreditation. Furthermore, the accreditation of the user includes providing a proof of accreditation. The proof of accreditation may be provided instantly on completion of the assessment of the social media skills. The proof of accreditation may be in form of a certificate. For example, the method 100 may provide for the immediate download of a customized certificate, business card and twitter background, which highlights that the user has been accredited. Further, it should be understood that additional certification may be provided from time and again based on any additional accreditation tests.

Alternatively, the proof of accreditation may be in form of an icon, which may be displayed on an interface, such as a website, used for the assessment of the social media skills of the user and displaying the profile of social media experts that have been already accredited. Accordingly, it should be understood that the user profile may have a plurality of proof of accreditation in front of his/her profile.

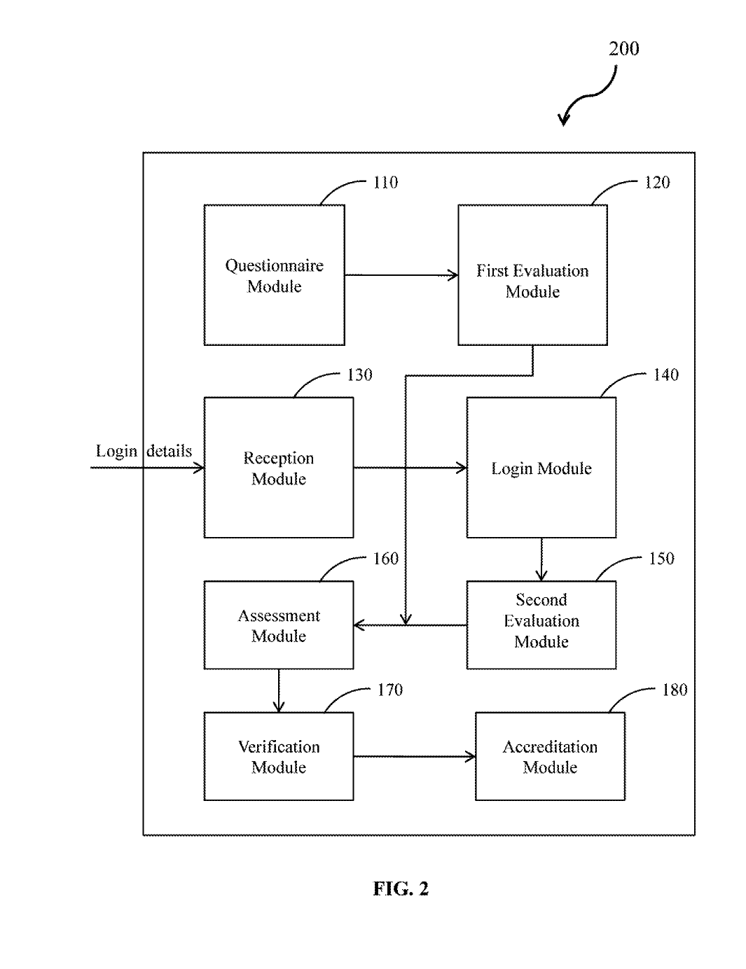

In another aspect, the present disclosure provides a system for assessing social media skills of a user registered on a plurality of networks. The system is depicted as system 200 in FIG. 2. As shown in FIG. 2, system 200 includes a questionnaire module 110, which may be configured to provide a questionnaire to the user. As described in reference to FIG. 1, the questionnaire includes one or more questions related to one or more networks of the plurality of networks. The questionnaire may be devised to determine whether the claims of expertise of the user are legitimate. It will be apparent to a person skilled in the art that the questionnaire module 110 may be driven by suitable software means for providing the questionnaire to the user.

Further, the system 200 includes a first evaluation module 120 coupled to the questionnaire module 110. The first evaluation module 120 may be configured to evaluate social media knowledge of the user. The evaluation may be based on answers provided by the user to the questionnaire. More specifically, the evaluation module 120 may be configured to parse the answers of the one or more questions in the questionnaire, and determine a score for the user based on the parsing of the answers. In one embodiment of the present disclosure, the first evaluation module 120 may be configured to determine whether the user possesses a minimum level of social media knowledge based on the parsing of the answers provided by the user. It will be apparent to a person skilled in the art that the evaluation module 110 may be driven by adequate software means known in the art and specifically configured to parse the questionnaire, and provide scores based on the parsing of the questionnaire, or determine whether the user possesses a minimum level of social media knowledge.

The system 200 further includes a reception module 130. The reception module 130 may be configured to receive login details of an account for at least one network of the plurality of networks of the user. The login details may be received from the user. For example, the user may provide login details about the social networking website on which he or she may be registered. The term ‘login details’ as mentioned herein refers to personal details, such as a username and password, as described in conjunction with FIG. 1. This information may be used to corroborate the presence of the user for the networks the user proclaims to be present on.

The system 200 may further include a login module 140 connected to the reception module 130. The login module 140 may be configured to logging into the at least one network, say the social networking website, with the login details received by the reception module 130. It should be understood that a successful login may corroborate the user presence on the network, whereas, an unsuccessful login may question the claims of the user.

The system 200 may also include a second evaluation module 150 connected to the login module 140. The second evaluation module 150 may be configured to evaluate social media presence of the user for the at least one network of the plurality of networks. The evaluation may be based on a pre-defined criterion similar to the pre-defined criterion explained in conjunction with FIG. 1. Accordingly, the evaluation module may include one or more of whether the account of the user is active, whether profile of the user exists, whether there is a profile image uploaded, whether the account contains posts, whether the account has content, whether the account is linked to other websites, and whether the account contains tags.

The system 200 may additionally include an assessment module 160 connected to the first evaluation module 120 and the second evaluation module 160. The assessment module 160 may be configured to assess the social media skills of user for the at least one network of the plurality of networks. The assessment may be based on result of evaluation of the social media knowledge and the social media presence. More specifically, the assessment may be based on the combined scores that the user may have obtained in the first evaluation module 120 and the second evaluation module 150 on the parameters related to the social media presence and the social media knowledge. Alternatively, the assessment may be based on whether the user has minimum level of social media presence and the social media knowledge as determined by the first evaluation module 120 and the second evaluation module 150, respectively.

The system 200 also includes a verification module 165 connected to the assessment module 160, and an accreditation module 170 connected to the assessment module 160. The verification module 165 may be configured to provide instant verification of completion of the assessment of the social media skills to the user. Such instant verification intimates the user that the assessment of the social media skills is complete.

The accreditation module 170 may be configured to accrediting the user based on the assessment of the social media skills. The accreditation may be of one or more levels of accreditation, wherein each of the one or more levels corresponds to the result of the social media skills assessment. Moreover, the accreditation module 170 may provide a proof of accreditation instantly on completion of the assessment of the social media skills. The proof may be a certificate, or an icon, wherein the icon is displayed on an interface used for the assessment of the social media skills of the user.

In yet another aspect, the present disclosure provides a computer program product, such as a Universal Serial Bus (USB) drive and a CD ROM, for use with a computer. The computer program product includes a computer usable medium having a computer readable program code stored thereon for assessing social media skills of a user registered on a plurality of networks. The computer program product performing the steps of providing a questionnaire to the user. The questionnaire may include one or more questions related to one or more networks as described in reference to FIGS. 1 and 2.

The computer program product may be further configured to perform the step of evaluating social media knowledge of the user. The evaluation being based on answers provided by the user to the questionnaire. Furthermore, the computer program may be configured to perform the step of receiving login details of an account for at least one network of the plurality of networks from the user, logging into the at least one network of the plurality of networks with the received login details, and evaluating social media presence of the user for the at least one network of the plurality of networks. The evaluation may be based on a pre-defined criterion as described in conjunction with FIGS. 1 and 2.

The computer program product may be configured to perform the step of assessing the social media skills of user for the at least one network of the plurality of networks. The assessment being based on result of evaluation of the social media knowledge and the social media presence.

After the assessment of the social media skills, the computer program product may also be additionally configured to perform the steps of providing instant verification of completion of the assessment of the social media skills to the user, and accrediting the user based on the assessment of the social media skills.

It should be clearly understood that the method, the system and the computer program product as described above, may be scalable to the enhancements of social media technologies. Moreover, the system and method may be easily added onto the existing platform to extend the extent of the testing. The system and method may also be used for verification of multiple social media sites' content. Alternatively, the system and method may also verify the amount of content and the duration of activity to date to supply exact social media skill credentials. Further, the system can also be used as a tool for searching for individual social activity for research purposes, such as HR screenings before being employed. Also, the interface where the icon of accreditation may be displayed may additionally include other features, such as training videos for setting up social medial profiles, and other features.

The present disclosure therefore provides a method, such as method 100, and a system, such as system 200, for assessing social media skills of a user registered on multiple networks. Further, the present disclosure provides a computer program product for assessing social media skills of a user registered on multiple networks. The method and the system provides for an evaluation of the social media skill when login details are provided by the user. Further, the method and the system provide for a tool for assessment and accreditation of social media skills by setting a standard in an industry without standards. Further, the assessment provided is a comprehensive assessment of social media skills of the individual partaking in the accreditation, and is based on facts rather than opinions. Also, the method and system provide an indisputable standard for the minimum requirement to be seen as an expert on a specific or multiple social media platforms—through real-time tests and verifications. The method and the system also establishes whether the user does indeed have the skill to establish a presence and engage in interaction through social media online, through actually verifying what they have done/are doing. Furthermore, the method and the system provide a one-stop accreditation mechanism for all social media platforms. It also establishes a base standard qualification by which all social media experts may be identified. This should bring credibility to the social media industry, as well as should protect consumers, who will now have a standard whereby experts can be identified. The method and the system may help individuals with skills in social media get an accreditation to help them further a career.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. (It is understood that various omission and substitutions of equivalents are contemplated as circumstance may suggest or render expedient, but such are intended to cover the application or implementation without departing from the spirit or scope of the claims of the present disclosure.)

What is claimed is:

1. A method for assessing social media skills of a user, the user being registered on a plurality of networks, the method comprising:
a. providing a questionnaire to the user, the questionnaire comprising one or more questions related to one or more networks;
b. evaluating social media knowledge of the user, the evaluation being based on answers provided by the user to the questionnaire;
c. receiving login details of an account for at least one network of the plurality of networks of the user, the login details being provided by the user;
d. logging into the at least one network of the plurality of networks with the received login details;
e. evaluating social media presence of the user for the at least one network of the plurality of networks, the evaluation being based on a pre-defined criteria; and
f. assessing the social media skills of user for the at least one network of the plurality of networks, the assessment being based on result of evaluation of the social media knowledge and the social media presence.

2. The method as recited in claim 1 further comprising providing instant verification of completion of the assessment of the social media skills to the user.

3. The method as recited in claim 1 further comprising accrediting the user based on the assessment of the social media skills.

4. The method as recited in claim 3, wherein accrediting the user comprises one or more levels of accreditation, the one or more levels corresponding to the result of the social media skills assessment.

5. The method as recited in claim 3, wherein accrediting the user comprises providing a proof of accreditation.

6. The method as recited in claim 5, wherein the proof of accreditation is a certificate.

7. The method as recited in claim 5, wherein the proof of accreditation is an icon, the icon being displayed on an interface used for the assessment of the social media skills of the user.

8. The method as recited in claim 5, wherein the proof of accreditation is provided instantly on completion of the assessment of the social media skills.

9. The method as recited in claim 1, wherein the at least one network of the plurality of networks being one of a social network, a professional network, a weblog and a website.

10. The method as recited in claim 1, wherein the pre-defined criteria comprises one or more of whether the account of the user is active, whether profile of the user exists, whether there is a profile image uploaded, whether the account contains posts, whether the account has content, whether the account is linked to other websites, and whether the account contains tags.

11. A system for assessing social media skills of a user, the user being registered on a plurality of networks, the system comprising:
a. a questionnaire module for providing a questionnaire to the user, the questionnaire comprising one or more questions related to one or more networks;
b. a first evaluation module for evaluating social media knowledge of the user, the evaluation being based on answers provided by the user to the questionnaire;
c. a reception module for receiving login details of an account for at least one network of the plurality of networks of the user, the login details being provided by the user;
d. a login module for logging into the at least one network of the plurality of networks with the received login details;
e. a second evaluation module for evaluating social media presence of the user for the at least one network of the plurality of networks, the evaluation being based on a pre-defined criteria; and
f. an assessment module for assessing the social media skills of user for the at least one network of the plurality of networks, the assessment being based on result of evaluation of the social media knowledge and the social media presence.

12. The system as recited in claim 11 further comprising a verification module for providing instant verification of completion of the assessment of the social media skills to the user.

13. The system as recited in claim 11 further comprising an accreditation module for accrediting the user based on the assessment of the social media skills.

14. The system as recited in claim 13, wherein the accreditation module comprises accreditation level module for one or more levels of accreditation, the one or more levels corresponding to the result of the social media skills assessment.

15. The system as recited in claim 13, wherein the accreditation module comprises providing a proof module for providing a proof of accreditation.

16. The system as recited in claim 15, wherein the proof of accreditation is a certificate.

17. The system as recited in claim 15, wherein the proof of accreditation is an icon, the icon an interface used for the assessment of the social media skills of the user.

18. The system as recited in claim 15, wherein the proof of accreditation is provided instantly on completion of the assessment of the social media skills.

19. The system as recited in claim 11, wherein the at least one network of the plurality of networks being one of a social network, a professional network, a weblog and a website.

20. The system as recited in claim 11, wherein the pre-defined criteria comprises one or more of whether the account of the user is active, whether profile of the user exists, whether there is a profile image uploaded, whether the account contains posts, whether the account has content, whether the account is linked to other websites, and whether the account contains tags.

21. A computer program product for use with a computer, the computer program product comprising a computer usable medium having a computer readable program code stored thereon for assessing social media skills of a user, the user being registered on a plurality of networks, the computer program product performing the steps of:
a. providing a questionnaire to the user, the questionnaire comprising one or more questions related to one or more networks;
b. evaluating social media knowledge of the user, the evaluation being based on answers provided by the user to the questionnaire;
c. receiving login details of an account for at least one network of the plurality of networks of the user, the login details being provided by the user;
d. logging into the at least one network of the plurality of networks with the received login details;
e. evaluating social media presence of the user for the at least one network of the plurality of networks, the evaluation being based on a pre-defined criteria; and
f. assessing the social media skills of user for the at least one network of the plurality of networks, the assessment being based on result of evaluation of the social media knowledge and the social media presence.

22. The computer program product as recited in claim 21 further comprising providing instant verification of completion of the assessment of the social media skills to the user.

23. The computer program product as recited in claim 21 further comprising accrediting the user based on the assessment of the social media skills.
